(19) United States
(12) Patent Application Publication
(10) Pub. No.: US 2017/0228795 A1
(43) Pub. Date: Aug. 10, 2017

(54) METHODS AND APPARATUS TO ASSOCIATE PANELIST DATA WITH CENSUS DATA

(71) Applicant: The Nielsen Company (US), LLC, New York, NY (US)

(72) Inventors: Achilleas Papakostas, Dallas, TX (US); Susan Cimino, Tampa, FL (US)

(21) Appl. No.: 15/017,275

(22) Filed: Feb. 5, 2016

(51) Int. Cl. G06Q 30/02; H04W 24/08; H04L 12/26; H04N 21/442; G06F 17/30

(52) U.S. Cl. CPC G06Q 30/0277; H04N 21/442; G06F 17/30864; H04L 43/08; G06Q 30/0246; H04W 24/08

(57) ABSTRACT

Methods, apparatus, systems and articles of manufacture to associate panelist data with census data are disclosed herein. An example method includes accessing a log of communications from a proxy. A record is identified from the log of communications. A panelist identifier associated with the record based on a port number used in a request represented by the record is determined. Whether a domain name of the request represented by the record matches a pattern including a census identifier is determined. In response to determining that the domain name of the request represented by the record matches the pattern, the census identifier is stored in association with the panelist identifier.

### FIELD OF THE DISCLOSURE

This disclosure relates generally to associating disparate data, and, more particularly, to methods and apparatus to associate panelist data with census data.

### BACKGROUND

In recent years, methods of accessing Internet media have evolved. For example, Internet media was formerly primarily accessed via computer systems such as desktop and laptop computers. Recently, handheld mobile devices (e.g., smartphones) have been introduced that allow users to request and view Internet media.

### BRIEF DESCRIPTION OF THE DRAWINGS

FIG. 1 is a block diagram of an example system constructed in accordance with the teachings of this disclosure to associate panelist data with census data.

FIG. 2 is a block diagram illustrating the example panelist monitoring system of the example audience measurement entity of FIG. 1.

FIG. 3 is a block diagram illustrating the example census monitoring system of the example audience measurement entity of FIG. 1.

FIG. 4 depicts example data tables that represent an example association of panelist IDs with census IDs.

FIG. 5 is a flowchart representative of example machine-readable instructions which, when executed by the mobile device of FIGS. 1 and 11, cause the mobile device to report census monitoring information.

FIG. 6 is a flowchart representative of example machine-readable instructions which, when executed by the census monitoring system of FIGS. 1, 3, and 11, cause the census monitoring system to collect monitoring information received from the mobile device.

FIG. 7 is a flowchart representative of example machine-readable instructions which, when executed by the panelist monitoring system of FIGS. 1, 2, and 11, cause the panelist monitoring system to associate a panelist ID with a census ID.

FIG. 8 is a flowchart representative of example machine-readable instructions which, when executed by the example reporting system of FIGS. 1 and 11, cause the example reporting system to prepare a report based on an association of the panelist ID and the census ID.

FIG. 9 is a block diagram of an example processor platform capable of executing the instructions of FIGS. 6, 7, and/or 8 to implement the example audience measurement entity of FIG. 1.

FIG. 10 is a block diagram of an example processor platform capable of executing the instructions of FIG. 5 to implement the example mobile device of FIGS. 1 and 11.

FIG. 11 illustrates an example alternative approach to associating a panelist ID with a census ID.

The figures are not to scale. Wherever possible, the same reference numbers will be used throughout the drawing(s) and accompanying written description to refer to the same or like parts.

### DETAILED DESCRIPTION

Monitoring companies desire to gain knowledge on how users interact with their handheld mobile devices, such as smartphones. For example, monitoring companies want to monitor Internet traffic to and/or from the handheld mobile devices to, among other things, monitor exposure to advertisements, determine advertisement effectiveness, determine user behavior, identify purchasing behavior associated with various demographics, credit application usage, etc. Some example monitoring systems utilize a census approach, where media presentations are monitored in association with an entire population of users in a specified geographic region. Media presentations may be monitored by, for example, reviewing web server logs, instructing media presentation devices to report media presentations. An example approach to instructing a media presentation device to report a media presentation is disclosed in Blumenau (U.S. Pat. No. 6,108,637), which is hereby incorporated by reference in its entirety. In an example census-based system, users may be issued a census ID to enable tracking of media presented to the user over time. For example, a web site that includes census monitoring functionality instructs a media device to report the census ID and an indication of the media presented. In some examples, census monitoring approach(es) may facilitate identification of how many unique users visited a particular web site. However, in some examples, census monitoring approach(es) might not be able to identify visitors to web sites that do not utilize the census monitoring functionality. Moreover, census style measurement(s) might not provide detailed demographic information about a particular user.

Some other known systems utilize a panelist system. In the panelist system, panelists are users that are registered on panels maintained by a ratings entity (e.g., an audience measurement company) that owns and/or operates the ratings entity subsystem. Traditionally, audience measurement entities (also referred to herein as “ratings entities”) determine demographic reach for advertising and media programming based on registered panel members. That is, an audience measurement entity enrolls people that consent to being monitored into a panel. During enrollment, the audience measurement entity receives demographic information from the enrolling people so that subsequent correlations may be made between advertisement/media exposure to those panelists and different demographic markets.

People become panelists via, for example, a user interface presented on a media device (e.g., via a website). People become panelists in additional or alternative manners such as, for example, via a telephone interview, by completing an online survey, etc. Additionally or alternatively, people may be contacted and/or enlisted using any desired methodology (e.g., random selection, statistical selection, phone solicitations, Internet advertisements, surveys, advertisements in shopping malls, product packaging, etc.).

In some examples disclosed herein, a proxy server (e.g., a proxy) is used to monitor panelists. A proxy relays communications from one device (e.g., a mobile device) to another (e.g., a web server), and vice versa. Using a proxy enables monitoring of the communications relayed between the devices. In such examples, each panelist is issued a panelist ID, and is given separate configuration information for use with the proxy. For example, each panelist may be assigned a unique identifier (e.g., a port number of the proxy server) for use with the proxy. A media presentation device of the panelist, when using the provided configuration information, transmits requests to Internet sites via the proxy. When using the unique identifier (e.g., the unique port number), the panelist is identifiable by the monitoring company when requests from the panelist's device arrive at the proxy (e.g., at the panelist-assigned port number of the proxy). In some examples, the communication options of the mobile device are configured separately for different interfaces for use with the proxy. For example, a Wi-Fi radio may be configured using a proxy auto configuration (PAC) file, while a cellular radio may be configured using a profile. Example systems, methods, and apparatus for configuring a mobile device to interact with a proxy are disclosed in U.S. patent application Ser. No. 12/856,651, filed on Aug. 14, 2010 and entitled “SYSTEMS, METHODS, AND APPARATUS TO MONITOR MOBILE INTERNET ACTIVITY”; Ser. No. 12/856,643, filed on Aug. 14, 2010 and entitled “SYSTEMS, METHODS, AND APPARATUS TO MONITOR MOBILE INTERNET ACTIVITY”; and Ser. No. 13/174,517, filed on Jun. 30, 2011 and entitled “SYSTEMS, METHODS, AND APPARATUS TO MONITOR MOBILE INTERNET ACTIVITY”, each of which is hereby incorporated herein by reference in their entirety.

Linking the panelist ID to the corresponding census ID enables better understanding of media presentations across various demographic segments. For example, demographic information collected via the panelist system, when combined with monitoring information collected via the panelist system, can be used to enhance the accuracy of estimates (e.g., estimates of how many times media has been presented, estimates of how many unique users have viewed the media, etc.) using monitoring information collected via the census system.

To enable such linking, the census system, in addition to instructing a media presentation device to report monitoring information to the census system, instructs the media presentation device to transmit a dummy request to a non-existent Internet address. In examples disclosed herein, the dummy request is a request that is not intended to request information for presentation and/or use at the device originating the request but, instead, is intended to convey monitoring information to the audience measurement entity. When the instruction is executed by a media presentation device of a panelist, the dummy request is transmitted to the non-existent Internet address via the proxy. In examples where a hypertext transfer protocol secure (HTTPS) is used, information in the payload of the dummy request is not made available to the proxy. However, to enable the proxy to route the request to its destination, a domain to which the dummy request is destined is made available to the proxy (e.g., the domain portion of the request is not encrypted). In examples disclosed herein, the non-existent Internet address includes a census ID in the domain name. For example, the dummy request is destined for a domain of “1234.webid.nielsen.com”, where 1234 represents the census ID. Because the dummy request is transmitted through the proxy, the panelist ID can be identified in association with the census ID of the dummy request.

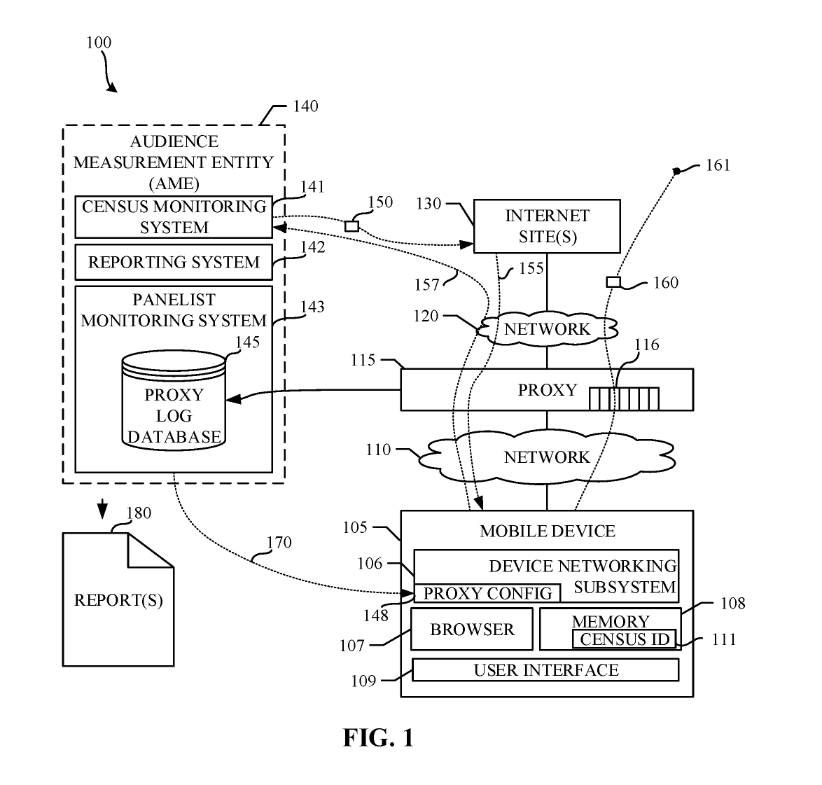

FIG. 1 is a block diagram of an example system 100 constructed in accordance with the teachings of this disclosure to associate panelist data with census data. The block diagram of FIG. 1 illustrates an example communication between the mobile device 105, a first network 110, the proxy 115, a second network 120, Internet site(s) 130, and an audience measurement entity 140. In the illustrated example of FIG. 1, the audience measurement entity includes a census monitoring system 141, a reporting system 142, and a panelist monitoring system 143. The panelist monitoring system 143 includes a proxy log database 145 that receives proxy logs from the proxy 115.

The example mobile device 105 of FIG. 1 is a handheld mobile device. In the illustrated example of FIG. 1, the mobile device 105 is a cellular phone. However, any other type of device may be used. For example, other types of phones (e.g., an Apple® iPhone®), a laptop computer, a desktop computer, a personal digital assistant (PDA), a netbook, or a tablet computer (e.g., an Apple® iPad™) may additionally or alternatively be used. The mobile device may be implemented with any mobile operating system, and may be implemented with any type of hardware and/or form factor. In the illustrated example, the mobile device communicates via a wireless communication interface. However, any other type(s) of communication interface may additionally or alternatively be used such as, for example, an Ethernet connection, a Bluetooth connection, a Wi-Fi connection, a cellular connection (e.g., a Time Division Multiple Access (TDMA) connection, Code Division Multiple Access (CDMA) connection, Worldwide Interoperability for Microwave Access (WiMAX) connection, Long Term Evolution (LTE) connection, etc.)

In the illustrated example, the mobile device 105 is associated with a panelist participating in a monitoring service. Although the example system of FIG. 1 is a panelist-based system, non-panelist and/or hybrid panelist systems may alternatively be employed. In the panelist system of the illustrated example, demographic information is obtained from the user when the user joins and/or registers for the panel. The demographic information may be obtained from the user via a telephone interview, by having the user complete an online survey, etc. Additionally or alternatively, panelists may be contacted and/or enlisted using any desired methodology (e.g., random selection, statistical selection, phone solicitations, Internet advertisements, surveys, advertisements in shopping malls, etc.).

In the illustrated example, a first panelist is associated with the mobile device 105. In the illustrated example, the mobile device 105 is owned, leased, or otherwise belongs to the first panelist. The monitoring entity of the illustrated example does not provide the mobile device to the first panelist. In other systems, panelists may be provided with mobile devices to participate in the panel. While in the illustrated example, the mobile device 105 is associated with a single panelist, the mobile device 105 may alternatively be associated with more than one panelist. For example, a family may have a single mobile device (e.g., a tablet computer) that may be shared amongst multiple users. The sharing of a client device is less common when the client device is a cellular phone than when the client device is a portable computer (e.g., an Apple® iPad™).

The mobile device 105 includes a device networking subsystem 106, a browser 107, a memory 108, and a user interface 109. The networking subsystem 106 provides a framework for transmitting and receiving media. The example networking subsystem 106 may be implemented via an application processor, a software system that facilitates networked communication, a browser engine, a baseband processor that transmits network traffic, and/or any other system that provides a framework for transmitting and receiving media. As used herein, the term “media” includes any type of content and/or advertisement delivered via any type of distribution medium. Thus, media includes television programming or advertisements, radio programming or advertisements, movies, web sites, streaming media, images, text, etc.

In the illustrated example, the networking subsystem 106 is implemented by the networking libraries provided in the Apple® iPhone® operating system. However, any other libraries, systems, or programs may additionally or alternatively be used. In examples disclosed herein, the device networking subsystem 106 operates using a proxy configuration 148 provided by the panelist monitoring system 143 (e.g., in the form of a file or data structure storing proxy configuration settings). The proxy configuration 148 directs the device networking subsystem 106 to transmit messages via the proxy 115.

The example browser 107 is an application that is executed by a processor of the mobile device 105. The browser 107 requests HyperText Transfer Protocol (HTTP) Internet media from the Internet site(s) 130, and renders the HTTP media for display. Additionally or alternatively, the example browser may request and render HTTPS Internet media. In some examples, the browser 107 is implemented by Apple® Safari® web browser. However, any other application may alternatively be used. For example, Pocket Internet Explorer may be used. In some examples, the HTTP Internet media is HTML media. However, the media may be presented in any format that may be rendered by the browser 107. Although the example browser 107 may initiate requests for media, in some devices, such as the Apple® iPhone® mobile telephone, requests are formatted and transmitted by the device networking subsystem 106 based on system wide settings that control routing and/or addressing of such requests (e.g., to a specific port 116 of the proxy 115).

The example memory 108 is a local memory of the mobile device 105. The example memory 108 of the illustrated example of FIG. 1 may be any device for storing data such as, for example, flash memory, magnetic media, optical media, etc. The example memory 108 is used for storing the census ID. In some examples, a portion of the memory 108 is used to implement HTML5 local storage. However, any other type of memory may additionally or alternatively be used.

The user interface 109 of the illustrated example provides a display to the user and receives input from the user. The example user interface 109 may include hardware, a graphics library, and/or a graphics driver for displaying media to the panelist, and may include hardware, an input library, and/or an input driver for receiving input from the panelist. Either or both the example browser 107 and/or the example application 108 may utilize the user interface to display media and/or receive input.

The first and second networks 110, 120 of the illustrated example of FIG. 1 are public networks (e.g., the Internet). However, a private network may instead be employed for one or both of the first and/or second networks 110, 120. For example, a network internal to an organization and/or company may be used to determine how members of the organization and/or employees of the company utilize mobile devices. In the illustrated example, the first and second networks 110, 120 are Internet Protocol (IP) version 4 (IPv4) based networks. However, any other networking technology may additionally or alternatively be implemented. For example, the networks 110, 120 may implement the IP version 6 (IPv6) protocol.

The proxy 115 of the illustrated example stores the requests for Internet media and/or portion(s) of such requests originating from the mobile device 105 in the proxy log database 145 in association with the proxy port numbers (e.g., corresponding to the proxy port 116 of FIG. 1) over which the request was received. Example data collected by the proxy 115 includes an IP Address of the mobile device 115, a proxy port number for a request (e.g., the port 116), a timestamp (e.g., a timestamp in a format such as: 2016-01-15 15:06:44-0400), a request method including a full requested URL and/or a query string, a status code of a response to the request, a size of a response to the request (e.g., a size of the payload, excluding headers), a User Agent, an X-DSID (e.g., a user ID for iTunes or App Store on a iPhone), an X-Apple-Client-Application field value (e.g., “Software” for AppStore, “WiFi-Music” for iTunes), a referrer, a content type of a response to the request, a total size of a response to the request (e.g., a total size of the payload and HTTP headers), and/or time taken to serve the request (e.g., in microseconds). In storing the requests, the proxy 115 may additionally store other identifiers such as, for example, the identifier of the mobile device 105, and/or an identifier of the panelist. Additionally or alternatively, the proxy 115 may store a portion of the Internet media and/or data (e.g., codes, signatures, etc.) representative of the Internet media in the proxy log database 145. For example, the proxy 115 may store the body of a webpage transmitted to the mobile device 105. In another example, the proxy 115 may store an identifier of an advertisement appearing on the webpage transmitted to the mobile device 105. This is particularly useful in situations where advertisements are rotated at websites. Additionally or alternatively, the proxy 115 may store characteristics of the response sent by the Internet site 130 based on the HTTP request, such as, for example the HTTP header, a status code of the HTTP header, a content type of the HTTP header, etc.

The Internet site(s) 130 supplies media to clients (e.g., the mobile device 105) via the Internet (e.g., the networks 110 and/or 120). In the illustrated example, the proxy 115 acts as an intermediary for the mobile device 105, and, thus, the proxy 115 is the client of the Internet site 130. Internet media is often supplied over port 80 of a web page server or media server hosting the Internet media, as most Internet media is in the form of HTTP data. However, any other port may be used to supply Internet media. For example, file transfer protocol (FTP) data may be transmitted over port 21, HTTP over Secure Socket Layer (SSL) may be transmitted over port 443, etc.

The Internet site(s) 130 can be implemented by any number and/or type of Internet site(s). For example, the Internet site(s) 130 may be implemented using a web server hosting webpages formatted as Hypertext Markup Language (HTML) media. Alternatively, the Internet site(s) 130 may be implemented using an application server providing application media (e.g., audio, video, text, images, etc.) to applications accessing Internet media. The application media may be formatted as HTML, XML, or may use any other protocol or port to return media to the requester. In some examples, the application data is implemented in a protocol specifically targeted for an application (e.g., a weather application) requesting media.

In some examples, the Internet site(s) 130 operate based on monitoring instructions 150 (of FIG. 1) received from the census monitoring system 141. For example, the census monitoring system 141 provides monitoring instructions 150 to the Internet site(s) 130. In this manner, the census monitoring system 141 can provide the monitoring instruction 150 to clients (e.g., the media device 105) as shown generally by arrow 155 to cause the clients to report monitoring information (e.g., an indication that the Internet site(s) 130 was visited) to the census monitoring system 141. As noted above, in addition to reporting monitoring information to the census monitoring system 141, the instructions cause the mobile device 105 to transmit a dummy request 160 to a non-existent Internet address 161. When the instruction is executed by the mobile device 105, the dummy request 160 is transmitted to the non-existent Internet address via the proxy 115, as a result of the proxy configuration 148 provided by the panelist monitoring system 143.

The panelist monitoring system 143 of the illustrated example of FIG. 1 enrolls users as panelists and provides the proxy configuration 148 (e.g., proxy configuration communication 170) to the mobile device 105. In examples disclosed herein, each mobile device 105 is assigned a unique proxy server address and/or proxy port (e.g., the proxy port 116) to enable unique identification of communications of the mobile device 105 as they are passed through the proxy 115. The proxy 115 creates a log of the traffic passing through the proxy 115, and provides the log to a central facility operated by the AME 140 (e.g., the Nielsen Company (US), LLC). In examples disclosed herein, the example AME 140 hosts a proxy log database 145 that stores proxy log information generated by the proxy server 115.

The panelist monitoring system 143 analyzes records stored in the proxy log database 145 to identify domain name patterns indicative of the non-existent Internet address 161 to which the dummy request 160 was transmitted. In some examples, the non-existent Internet address does not exist as a result of an included Internet sub-domain (e.g., 1234.webid.nielsen.com, where 1234 specifies a sub-domain of webid.nielsen.com). In such an example, a server responding to requests received at the webid.nielsen.com might respond with an error message indicating that the requested sub-domain (e.g., the sub domain of “1234”) was not found. In some examples, the panelist monitoring system 143 additionally inspects the records stored in the proxy log database 145 to identify such error messages. In examples disclosed herein, the panelist monitoring system 143 extracts the census ID from the address of the non-existent Internet address 161, and associates the census ID with the panelist based on the proxy server address and/or port 116 via which the dummy request 160 was received by the proxy 115.

The example reporting system 142 of the illustrated example of FIG. 1, based on the associations identified by the panelist monitoring system 143, prepares reports 180 that use both information collected using both the census monitoring system 141 and the panelist monitoring system 143. Such reports 180 may, for example, utilize demographic information of panelists to supplement and/or correct demographic information estimated in association with the census monitoring information.

In the illustrated example, the example proxy 115 and the example AME 140 are shown as separate computing systems. However, the example proxy 115 and the example AME 140 may alternatively be implemented as a single computing system. In the illustrated example, the monitoring system 100 includes the example proxy 115 and the example AME 140. However, additional structures may be implemented to carry out one or more portions of the functionalities implemented by the example proxy 115, the example AME 140, and/or other structures associated with one or more additional and/or alternative functions.

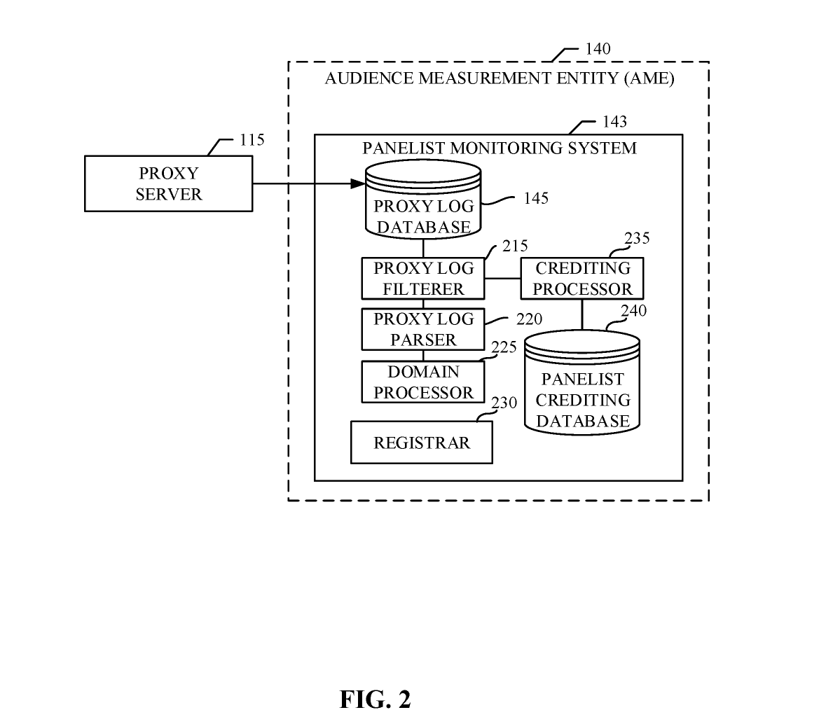

FIG. 2 is a block diagram illustrating the example audience measurement entity 140 of FIG. 1. The example AME 140 of FIG. 2 includes the panelist monitoring system 143. In examples disclosed herein, the example panelist monitoring system 143 is implemented by one or more servers. The example panelist monitoring system 143 of FIG. 2 includes the example proxy log database 145, an example proxy log filterer 215, an example proxy log parser 220, an example domain processor 225, an example registrar 230, an example crediting processor 235, and an example panelist crediting database 240.

The example proxy log filterer 215 of the illustrated example of FIG. 2 filters requests received by the proxy 115 and stored in the proxy log database 145 based on one or more filters and/or filter criteria. The example proxy log filterer 215 creates a filtered request log that is inspected by the example proxy log parser 220. In the illustrated example, the proxy log filterer 215 filters requests based on, for example, a port number (e.g., corresponding to the port 116 of FIG. 1 assigned to the mobile device 105) of the received request 160 (of FIG. 1), a user agent of the received request 160 (of FIG. 1), a URL of the received request 160 (of FIG. 1), a content type of the received request 160 (of FIG. 1), an HTTP status message of the received request 160 (of FIG. 1), an HTTP status code of a message returned to the proxy 115 by the media provider 130, a parameter of an HTTP response received by the proxy 115 (e.g., a response by the Internet site 130 based on the request 160 (of FIG. 1) transmitted to the Internet site(s) 130 by the proxy 115 on behalf of the mobile device 105), etc. In examples disclosed herein, the example proxy log filterer 215 filters requests and/or responses to remove records that are not related to crediting. For example, the example proxy log filterer 215 may remove records that contain invalid information, data errors (e.g., messages including an HTTP status code indicating that there was an error in serving the response), duplicate records, etc.

The example proxy log parser 220 of the illustrated example of FIG. 1 parses filtered proxy logs created by the example proxy log filterer 215. In examples disclosed herein, the example proxy log parser 220 inspects the filtered proxy log to identify, for example, response messages that indicate that a sub-domain of the dummy request was not found, a number of records appearing in the filtered proxy log, a number of unique user agents appearing in the filtered proxy log, a number of ports used in the filtered proxy log, etc.

The domain processor 225 of the illustrated example of FIG. 1 inspects records of the example filtered proxy log to identify, for example, sub-domains indicative of a census ID 111. In examples disclosed herein, the example domain processor 225 inspects a domain field of requests received by the proxy 115 to identify when a pattern indicative of the presence of a census ID 111 is present. For example, a pattern of a domain name having a four digit number followed by “.webid.nielsen.com” may be used, where the four digit number is representative of the census ID 111. Of course, other patterns may additionally or alternatively be used such as, for example, a domain name including twenty five hexadecimal characters followed by “.webid.nielsen.com” might be used. In examples disclosed herein, the domain name to which the dummy request 160 is addressed is used because the domain name is available for parsing when the dummy request 160 is transmitted using HTTPS. In some examples, other portions of the dummy request 160 (e.g., a body of the dummy request, a header field of the dummy request, etc.) may be used. In some examples, the dummy request 160 is decrypted to enable identification of the census ID 111 included therein.

In the example of FIG. 1, the registrar 230 receives registration information from a panelist and stores a record identifying the panelist and/or the panelist's media device 105. In the illustrated example, a panelist identifier is stored in association with a port number assigned to the panelist (e.g., the port 116 assigned to the panelist may be 50,000 and the panelist identifier may be “Panelist A”). In the illustrated example, the received registration information includes demographic information. However, any other information may additionally or alternatively be collected. The registration information may include, for example, information identifying the model of the mobile device 105 associated with the panelist, a mailing address associated with the panelist, an email address associated with the panelist, a phone number associated with the mobile device 105, a unique identifier of the panelist and/or mobile device 105 (e.g., a social security number of the panelist, a phone number of the mobile device 105, a zip code of the panelist, and/or any combination or derivation of any information related to the panelist and/or the mobile device 105), the age of the panelist, the gender of the panelist, the race of the panelist, the marital status of the panelist, the income of the panelist and/or the household of the panelist, the employment status of the panelist, where the panelist typically intend to use the mobile device 105, how long the panelist has owned the mobile device 105, the education level of the panelist, and/or any other information related to the panelist and/or the mobile device 105.

The example crediting processor 235 of the illustrated example of FIG. 1 processes records stored in the proxy log database 145 to identify usage sessions and/or durations associated with those usage sessions (e.g., how long an application was used, how long a website was viewed, etc.). Example approaches for crediting a usage session are disclosed in U.S. Patent Application Ser. No. 62/113,177 filed on Feb. 6, 2015 and entitled “METHODS AND APPARATUS TO MONITOR A MEDIA PRESENTATION”; Ser. No. 13/840,594 filed on Mar. 15, 2015 and entitled “METHODS AND APPARATUS TO CREDIT INTERNET USAGE”; and Ser. No. 13/840,543 filed on Mar. 15, 2013 and entitled “METHODS AND APPARATUS TO CREDIT USAGE OF MOBILE DEVICES”, which are hereby incorporated by reference herein in their entireties. In some examples, the example proxy log falterer 215 filters the records of the proxy log database 145 prior to crediting by the crediting processor 235 to ensure that messages that are not related to crediting and/or creditable events do not affect the monitoring result of the crediting processor 235. The example crediting processor 235 stores the result of the crediting operations in the panelist crediting database 240.

The example panelist crediting database 240 of the illustrated example of FIG. 2 may be any device for storing data such as, for example, flash memory, magnetic media, optical media, etc. Furthermore, the data stored in the example panelist crediting database 240 may be in any data format such as, for example, binary data, comma delimited data, tab delimited data, structured query language (SQL) structures, etc. While in the illustrated example the example panelist crediting database 240 is illustrated as a single database, the example panelist crediting database 240 may be implemented by multiple databases. The example panelist crediting database 240 stores crediting data generated by the crediting processor 235. Such crediting data enables, for example, a panelist to be associated with particular Internet activity (e.g., streaming media, using apps, viewing websites, etc.). More generally, the crediting data enables demographic groupings of panelists to be associated with various Internet activities. Such associations are useful to the AME 140 to enable identification of, for example, which demographic groups perform different types of Internet activities.

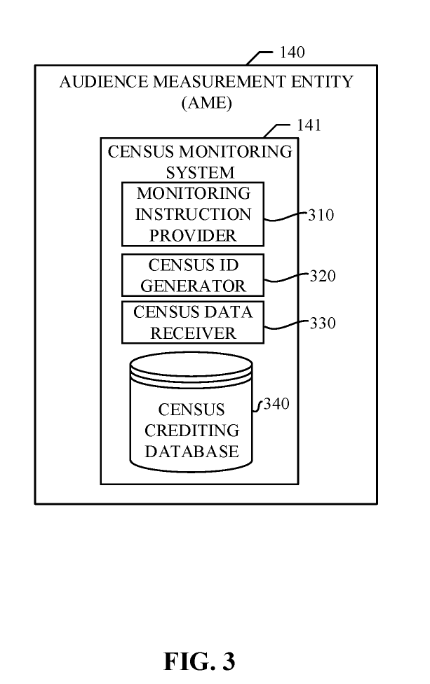

FIG. 3 is a block diagram illustrating the example audience measurement entity 140 of FIG. 1. The example AME 140 of FIG. 3 includes the census monitoring system 141. In examples disclosed herein, the census monitoring system 141 is implemented by one or more servers. The example census monitoring system 141 of FIG. 3 includes an example monitoring instruction provider 310, an example census ID generator 320, an example census data receiver 330, and an example census crediting database 340.

The example monitoring instruction provider 310 of the illustrated example of FIG. 3 provides monitoring instructions 150 (of FIG. 1) to the Internet site(s) 130. In examples disclosed herein, the monitoring instructions 150 (of FIG. 1) are implemented as JavaScript instructions that are to be included in and/or referenced in a webpage provided by the Internet site(s) 130 to the mobile device 105. However, the monitoring instructions 150 (of FIG. 1) may be implemented in any other fashion. In examples disclosed herein, the monitoring instructions 150 (of FIG. 1), when executed by the mobile device 105, cause the mobile device 105 to communicate with the census data receiver 330 of the example census monitoring system 141 to identify media accessed and/or presented via the mobile device 105. In some examples, the monitoring instructions 150 (of FIG. 1) cause the mobile device 105 to report a census ID 111 to the census data receiver 330 along with the identification of the media. In some other examples, the mobile device 105 might not yet have been assigned a census ID 111. In such an example, the census ID generator 320 generates and provides the census ID 111 to the mobile device 105 for use in subsequent messages to the census monitoring system 141.

As noted above, in addition to instructing the mobile device 105 to report monitoring information to the census monitoring system 141, the monitoring instructions 150 (of FIG. 1) cause the mobile device 105 to transmit a dummy request to a non-existent Internet address. In examples disclosed herein, the monitoring instructions 150 cause the mobile device 105 to determine the non-existent Internet address using the census ID 111 provided by the census ID generator 320. In examples disclosed herein, the census ID 111 is used as a portion of the domain name of the non-existent Internet address. Using the census ID 111 in the domain name of the non-existent Internet address enables recordation of the census ID 111 in the log(s) stored by the proxy and, thus, enables association of a panelist ID with the census ID 111.

The example census ID generator 320 of the illustrated example of FIG. 3 generates and provides a census ID 111 to the mobile device 105. In examples disclosed herein, the example census ID generator 320 causes the generated census ID 111 to be stored in the memory 108 of the mobile device 105. As noted above, the example memory 108 may be used to implement HTML5 local storage and, as such, may persist for a period of time (e.g., one week, one month, one year, etc.). As such, the census ID 111 generated by the census ID generator 320 will typically be associated with a same mobile device for a corresponding period of time. In examples disclosed herein, the census ID 111 is generated as a decimal number. However, any other past, present, and/or future types and/or formats of census ID(s) may additionally or alternatively be used. For example, the census ID 111 may be generated as a hexadecimal string of characters.

The example census data receiver 330 receives monitoring messages from the mobile device 105. In examples disclosed herein the monitoring message includes an identification (e.g., a media ID) of the presented media. In some examples, the monitoring message includes the census ID 111 assigned to the mobile device 105. In some other examples, the monitoring message does not include an assigned census ID 111 and, accordingly, a census ID 111 can then be generated for the mobile device. Upon receipt of the monitoring message, the census data receiver 330 stores monitoring information included in the monitoring message in the example census crediting database 340.

The example census crediting database 340 of the illustrated example of FIG. 3 may be any device for storing data such as, for example, flash memory, magnetic media, optical media, etc. Furthermore, the data stored in the example census crediting database 340 may be in any data format such as, for example, binary data, comma delimited data, tab delimited data, structured query language (SQL) structures, etc. While in the illustrated example the example census crediting database 340 is illustrated as a single database, the example census crediting database 340 may be implemented by multiple databases. The example census crediting database 340 stores crediting data received and/or generated by the crediting processor 235. Such crediting data enables, for example, the census ID 111 to be associated with particular Internet activity (e.g., streaming media, using apps, viewing websites, etc.). More generally, the crediting data enables analysis of various Internet activities.

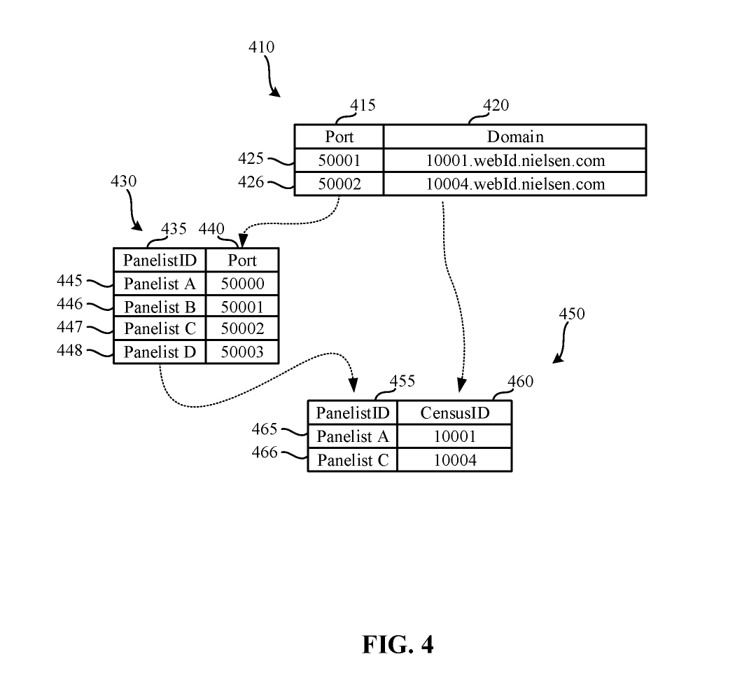

FIG. 4 depicts example data tables that represent an example association of panelist IDs with census IDs. The illustrated example of FIG. 4 includes a proxy log table 410 that identifies requests received via the proxy 115 (FIGS. 1 and 2). The example proxy log table 410 includes a port column 415 representing the port 116 of the proxy 115 on which the message was received. The example proxy log table 410 includes a domain column 420 representing the domain to which the message was directed. The illustrated example of FIG. 4 includes a panelist ID table 430 that identifies an association of a port used by the proxy 115 for a particular panelist and the panelist ID assigned to that panelist. The example panelist ID table 430 includes a panelist ID column 435 and an assigned port column 440. The illustrated example of FIG. 4 includes a panelist ID to census ID association table 450 that includes a panelist ID column 455 and a census ID column 460.

The example proxy log table 410 represents records of messages received by the proxy 115. In examples disclosed herein, the proxy 115 stores a record (e.g., in the example port column 415) of the port 116 on which the proxy 115 received the message (e.g., the dummy request 160 of FIG. 1), and stores a record of the domain to which the message was destined (e.g., in the example domain column 420). In examples disclosed herein, the example proxy log table 410 includes two example records. A first example record 425 indicates that a message (e.g., the dummy request 160) was received via port “50000” and was destined for the domain “10001.webId.nielsen.com”. In the illustrated example of FIG. 4, the “10001” portion of the domain represents the census ID 111. A second example record 426 indicates that a message was received via port “50002” and was destined for the domain “10004.webId.nielsen.com”.

The example panelist ID table 430 identifies associations of ports assigned to particular panelists. In the illustrated example of FIG. 4, four records 445, 446, 447, 448 are shown. However, in practice, many records will be used to associate each panelist to one or more ports. For example, there may be ten thousand records corresponding to a panel including ten thousand panelists. In the illustrated example of FIG. 4, “Panelist A” is associated with port “50000,” “Panelist B” is associated with port “50001,” “Panelist C” is associated with port “50002,” and “Panelist D” is associated with port “50003.” In some examples, a panelist might be associated with multiple different ports. For example, a first port may be used by the mobile device 105 of the panelist when communicating via a cellular communication path, and a second port different from the first port may be used by the mobile device 105 when communicating via a WiFi communication path.

The example panelist ID to census ID association table 450 represents calculated associations of a panelist ID (represented in the panelist ID column 455) and a census ID (represented in the census ID column 460). In the illustrated example of FIG. 4, the example panelist ID to census ID association table 450 shows that the panelist ID of “Panelist A” is associated with the census ID of “10001,” and that the panelist ID of “Panelist C” is associated with the census ID of “10004.” In the illustrated example of FIG. 4, the panelist ID of the example panelist ID to census ID association table 450 is derived by performing a lookup of the panelist ID in the panelist ID table 430 based on the port from a particular record in the proxy log table 410. In the illustrated example of FIG. 4, the census ID of the example panelist ID to census ID association table 450 is derived by parsing the domain used in the dummy request 160 corresponding to the record used to derive the panelist ID.

While an example manner of implementing the example audience measurement entity 140 of FIG. 1 is illustrated in FIGS. 1, 2, and/or 3, one or more of the elements, processes and/or devices illustrated in FIGS. 1, 2, and/or 3 may be combined, divided, re-arranged, omitted, eliminated and/or implemented in any other way. Further, the example proxy log filterer 215, the example proxy log parser 220, the example domain processor 225, the example registrar 230, the example crediting processor 235, and/or, more generally, the example panelist monitoring system 143, the example monitoring instruction provider 310, the example census ID generator 320, the example census data receiver 330, and/or, more generally, the example census monitoring system 141, the example reporting system 142, and/or, more generally, the example audience measurement entity 140 of FIGS. 1, 2, and/or 3 may be implemented by hardware, software, firmware and/or any combination of hardware, software and/or firmware. Thus, for example, any of the example proxy log filterer 215, the example proxy log parser 220, the example domain processor 225, the example registrar 230, the example crediting processor 235, and/or, more generally, the example panelist monitoring system 143, the example monitoring instruction provider 310, the example census ID generator 320, the example census data receiver 330, and/or, more generally, the example census monitoring system 141, the example reporting system 142, and/or, more generally, the example audience measurement entity 140 of FIGS. 1, 2, and/or 3 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example proxy log falterer 215, the example proxy log parser 220, the example domain processor 225, the example registrar 230, the example crediting processor 235, and/or, more generally, the example panelist monitoring system 143, the example monitoring instruction provider 310, the example census ID generator 320, the example census data receiver 330, and/or, more generally, the example census monitoring system 141, the example reporting system 142, and/or, more generally, the example audience measurement entity 140 of FIGS. 1, 2, and/or 3 is/are hereby expressly defined to include a tangible computer readable storage device or storage disk such as a memory, a digital versatile disk (DVD), a compact disk (CD), a Blu-ray disk, etc. storing the software and/or firmware. Further still, the example audience measurement entity 130 of FIGS. 1, 2, and/or 3 may include one or more elements, processes and/or devices in addition to, or instead of, those illustrated in FIGS. 1, 2, and/or 3, and/or may include more than one of any or all of the illustrated elements, processes and devices.

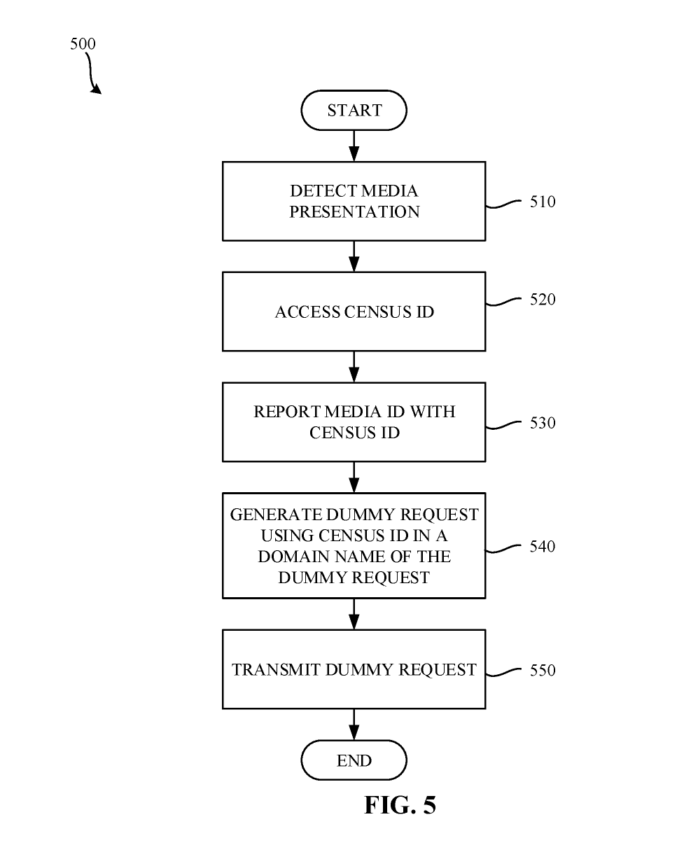

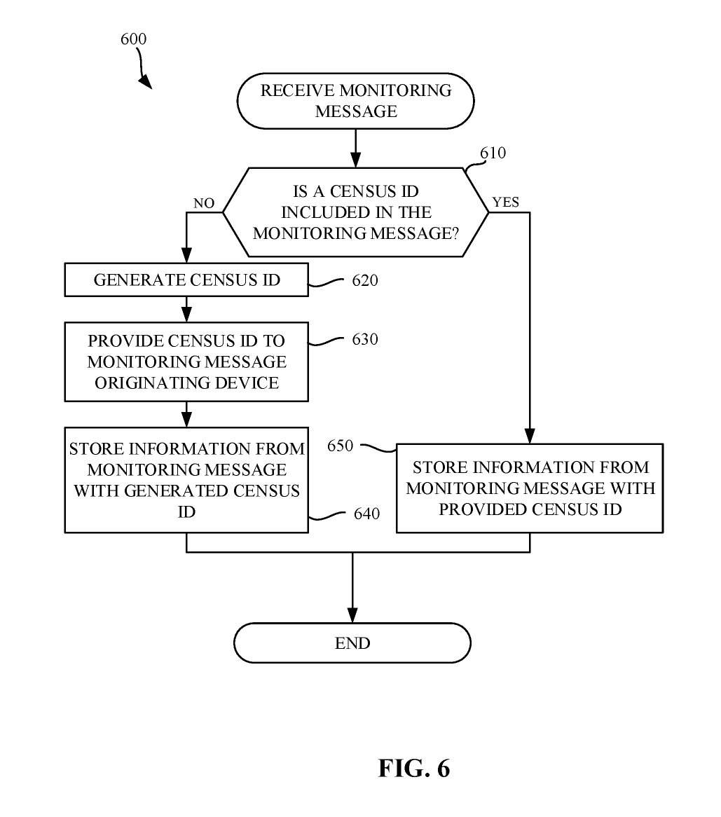

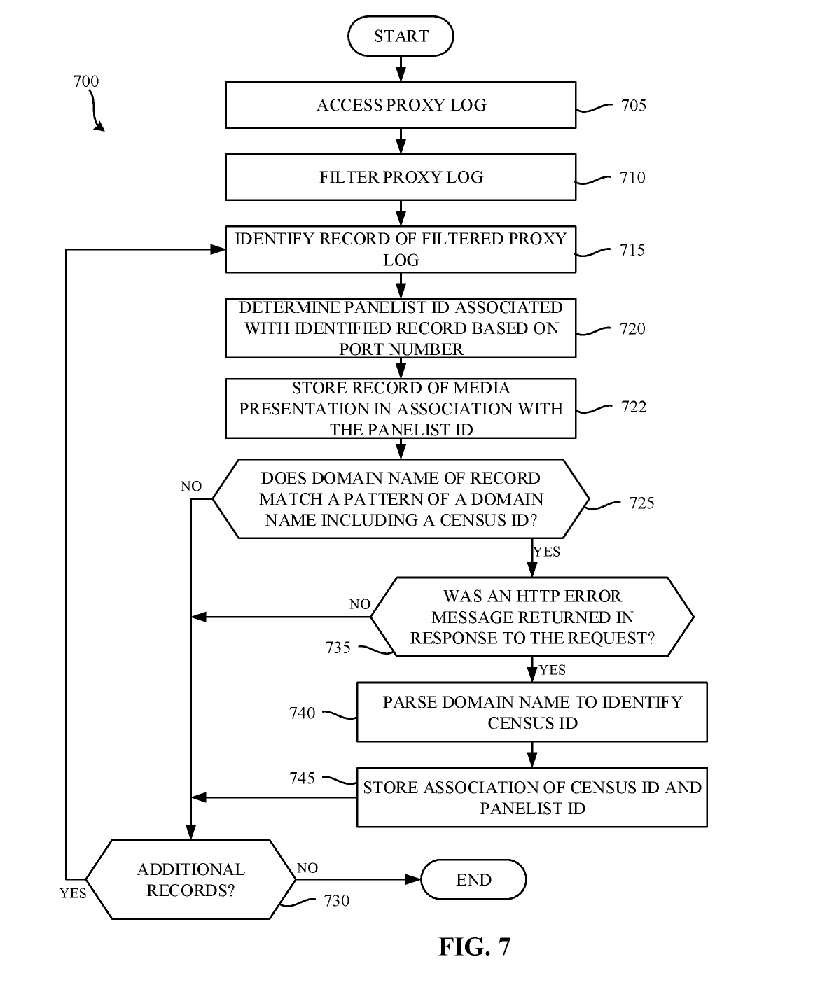

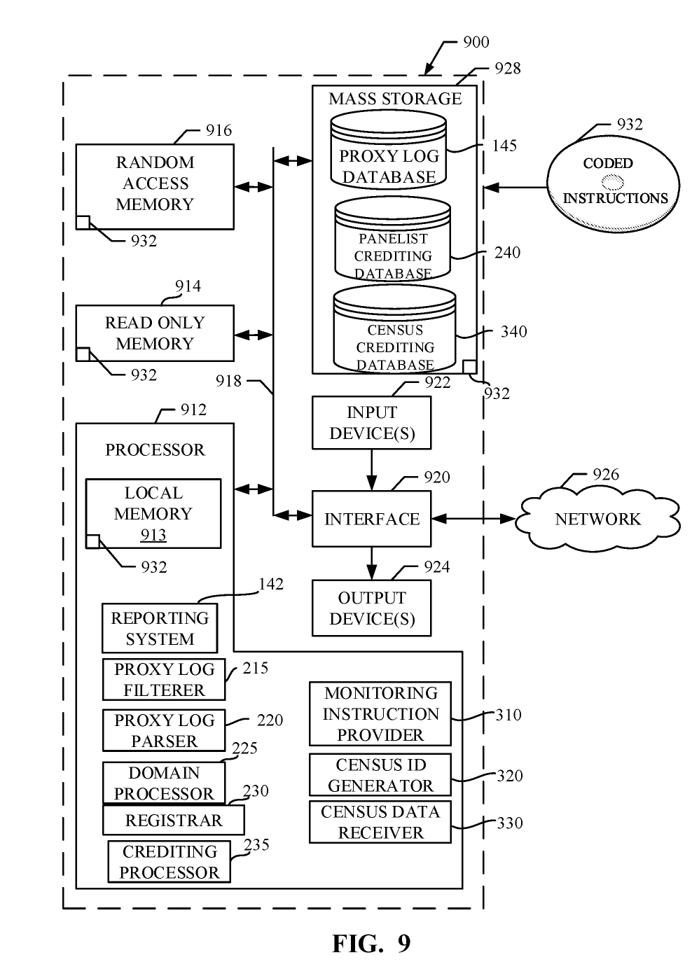

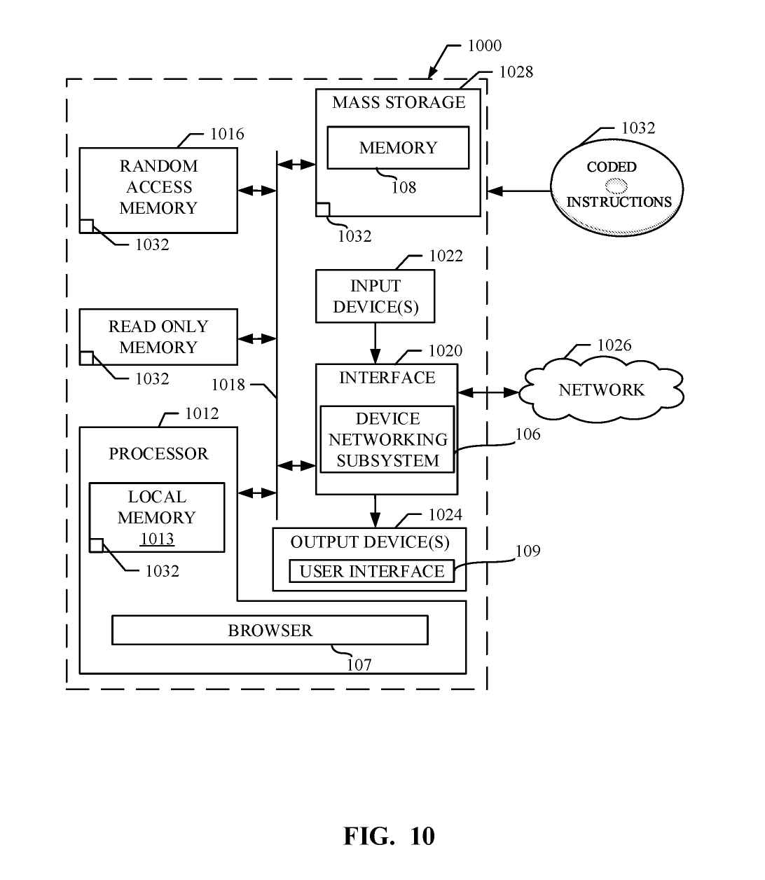

A flowchart representative of example machine readable instructions for implementing the example mobile device 105 of FIG. 1 is shown in FIG. 5. Flowcharts representative of example machine readable instructions for implementing the example audience measurement entity 140 of FIGS. 1, 2, and/or 3 are shown in FIGS. 6, 7, and/or 8. In these examples, the machine readable instructions comprise a program for execution by a processor such as the processor 912 shown in the example processor platform 900 discussed below in connection with FIG. 9, and/or the processor 1012 shown in the example processor platform 1000 discussed below in connection with FIG. 10. The program may be embodied in software stored on a tangible computer readable storage medium such as a CD-ROM, a floppy disk, a hard drive, a digital versatile disk (DVD), a Blu-ray disk, or a memory associated with the processor 912, the processor 1012, but the entire program and/or parts thereof could alternatively be executed by a device other than the processor 912, the processor 1012, and/or embodied in firmware or dedicated hardware. Further, although the example program(s) is/are described with reference to the flowchart(s) illustrated in FIGS. 5, 6, 7, and/or 8, many other methods of implementing the example mobile device 105 and/or the example audience measurement entity 140 may alternatively be used. For example, the order of execution of the blocks may be changed, and/or some of the blocks described may be changed, eliminated, or combined.

As mentioned above, the example processes of FIGS. 5, 6, 7, and/or 8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 5, 6, 7, and/or 8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 5 is a flowchart representative of example machine-readable instructions 500 which, when executed by the mobile device 105 (FIG. 1), cause the mobile device 105 to report census monitoring information. In the illustrated example of FIG. 5, the example machine-readable instructions additionally cause the mobile device 105 to transmit a dummy request (e.g., the dummy request 160 of FIG. 1). The program of FIG. 5 begins when the mobile device 105 detects a media presentation. (Block 510). In examples disclosed herein, the media presentation may be identified by, for example, an indication that the media is included in a webpage presented by the media device 105. However, any other approach to identifying a media presentation may additionally or alternatively be used. The media device 105 identifies the census ID 111 stored in the memory 108. (Block 520). The media device 105 then transmits a monitoring message 157 to the census monitoring system 141 reporting a media ID and the census ID 111. (Block 530). However, in some examples, the media device 105 might not have a census ID 111 stored in the memory 108. In such examples, the monitoring message 157 may be sent without a census ID 111. The census monitoring system 141 then responds with the census ID 111 to be used in subsequent monitoring messages.

The mobile device 105 then generates a dummy request 160 using the census ID 111 in the domain name of the dummy request. (Block 540). Using the census ID 111 in the domain name of the dummy request ensures that, if the user is also a panelist and the mobile device 105 is configured to route communications through the proxy 115, that the census ID 111 can later be identified via communications transmitted via the proxy 115. In examples disclosed herein, the census ID 111 is used in the domain name. However, in some examples, the census ID 111 may be modified for use in the domain name. For example, the census ID 111 may be transformed (e.g., hashed, reversed, encrypted, modified, etc.) to ensure that the census ID 111 is not transmitted in an unprotected manner such that others could intercept the dummy request and identify the census ID 111. A corresponding de-transformation may later be performed to identify the census ID 111. The mobile device 105 then transmits the dummy request 160. (Block 550). In examples disclosed herein, the dummy request 160 is not intended to retrieve information, but instead is intended to convey the census ID 111 (or a transformation thereof) in a manner that facilitates association with a panelist ID.

FIG. 6 is a flowchart representative of example machine-readable instructions 600 which, when executed by the census monitoring system 141 (FIGS. 1 and/or 3), cause the census monitoring system 141 to collect monitoring information received from the mobile device 105. The example program 600 of FIG. 6 begins upon receipt of a census monitoring message from the mobile device 105 (e.g., transmitted by the mobile device 105 when executing block 530 of FIG. 5). The example census data receiver 330 determines whether a census ID is included in the received monitoring message. (Block 610). In examples disclosed herein, the example census data receiver 330 inspects a header field of the monitoring message (e.g., a cookie field) to determine whether a census ID was included. However, in some examples, the example census data receiver 330 may inspect a payload of the monitoring message to determine whether the census ID was included.

If the census ID is not included (Block 610 returns a result of NO), the example census ID generator 320 generates the census ID 111. (Block 620). In examples disclosed herein, the census ID 111 is generated by issuing a next sequential census ID (e.g., census ID “10001” is generated, then census ID “10002” is generated, then census ID “10003” is generated, etc.). However, any other approach to generate a census ID 111 may additionally or alternatively be used. Upon generation of the census ID, the census ID generator 320 provides the census ID to the mobile device 105 that originated the received monitoring message. (Block 630). The example census data receiver 330 then stores information from the monitoring message in association with the generated census ID in the census crediting database 340. (Block 640). In some examples, the census data receiver 330 stores a portion of the information from the monitoring message 157. However, in some examples, the census data receiver 330 stores the entirety of the monitoring message 157. In some other examples, additional information not included in the monitoring message 157 itself may additionally be stored such as, for example, a timestamp corresponding to a time of receipt of the monitoring message 157.

Returning to block 610, if the census ID 111 is included (Block 610 returns a result of YES), the example census data receiver 330 stores information from the monitoring message 157 in association with the received census ID in the census crediting database 340. (Block 650). As above, in some examples, the census data receiver 330 stores a portion of the information from the monitoring message 157. In some examples, the census data receiver 330 stores the entirety of the monitoring message 157. In some other examples, additional information not included in the monitoring message 157 itself may additionally be stored such as, for example, a timestamp corresponding to the time of receipt of the monitoring message 157. The example program 600 of FIG. 6 then terminates. The example program 600 of FIG. 6 may then again be executed (e.g., in serial and/or in parallel) in response to incoming monitoring messages.

In some examples, a redirect message is transmitted to the mobile device 105 by the census data receiver 330 to cause the mobile device 105 to transmit the dummy request 160 (FIG. 1). Using such an approach, the example census monitoring system 141 may periodically instruct the mobile device 105 to transmit the dummy request 160. In some examples, the example census data receiver 330 may consult, for example, the example panelist ID to census ID association table 450 to determine if a panelist ID is already known in association with the census ID 111. If, for example, the panelist ID is already known in association with the census ID, the mobile device 105 may not be instructed to transmit the dummy request. Not instructing the mobile device 105 to transmit the dummy request reduces an amount of network communications transmitted by the mobile device 105.

FIG. 7 is a flowchart representative of example machine-readable instructions 700 which, when executed by the panelist monitoring system 143, cause the panelist monitoring system 143 to associate a panelist ID with a census ID. The example program 700 of FIG. 7 begins when the example proxy log falterer 215 accesses the proxy log stored in the proxy log database 145. (Block 705). In examples disclosed herein, the example proxy log is accessed periodically (e.g., once per hour, once per day, etc.). However, the example proxy log may be accessed in any other fashion such as, for example, in response to a request. The example proxy log filterer 215 then filters the proxy log. (Block 710). The example proxy log filterer 215 may filter the example proxy log to, for example, remove records that are not related to crediting. For example, the example proxy log filterer 215 may remove records that contain invalid information, data errors (e.g., messages including an HTTP status code indicating that there was an error in serving the response), duplicate records, etc.

The example proxy log parser 220 then identifies a record of the filtered proxy log. (Block 715). In examples disclosed herein, the filtered proxy log is processed sequentially according to a timestamp corresponding to a time of receipt of the record. However, the filtered proxy log may be processed in any other fashion. With respect to the identified record from the filtered proxy log, the example crediting processor 235 determines a panelist ID based on the port number used in the request represented by the record. For example, the example crediting processor 235 may identify the port number, and perform a lookup using, for example the panelist ID table 430 of FIG. 4 to determine the panelist ID. The example crediting processor 235 stores a record of a media presentation corresponding to the record in the panelist crediting database 240 in association with the identified panelist ID. (Block 722).

The example domain processor 225 determines whether the domain name of the record matches a pattern of a domain name that includes a census ID. (Block 725) In examples disclosed herein, the example domain processor 225 inspects a domain field of the request to identify whether the domain name matches a pattern indicative of the presence of a census ID. For example, a pattern of a domain name having a four digit number followed by “.webid.nielsen.com” may be used, where the four digit number is representative of the census ID. Of course, other patterns may additionally or alternatively be used such as, for example, a domain name including twenty five hexadecimal characters followed by “.webid.nielsen.com”. In examples disclosed herein, the domain name to which the dummy request is used because the domain name is available for parsing when the dummy request 160 is transmitted using HTTPS. In some examples, other portions of the dummy request (e.g., a body of the dummy request, a header field of the dummy request, etc.) may be used. In some examples, the dummy request is decrypted to enable identification of the census ID included therein.

If the domain name does not match the pattern (Block 725 returns a result of NO), the example proxy log parser 220 determines whether there are any additional records to be processed (Block 730). If additional records are to be processed, control proceeds to block 715 where the processes is repeated.

If the domain name does match the pattern (Block 725 returns a result of YES), the example domain processor 225 determines whether an HTTP error message was returned in response to the request. (Block 735). In some examples, the proxy log additionally stores response code information indicative of the response received as a result of the dummy request 160. In some examples, a server of a higher-level domain (e.g., a server responsive to the domain name “webId.nielsen.com”, a server responsive to the domain name “nielsen.com”) may have responded with an HTTP error message indicating that the server having the domain name including the census ID (e.g., “1234.webId.nielsen.com”) does not exist. The presence of the error message returned in response to the request further indicates that the initial message was meant for linking a panelist ID and a census ID. For example, the presence of the error message returned in response to the request reduces the likelihood of a false linking between a panelist ID and a census ID. In the illustrated example of FIG. 7, if no HTTP error message was returned (Block 735 returns a result of NO), the example proxy log parser 220 determines whether there are any additional records to be processed (Block 730). If additional records are to be processed, control proceeds to block 715 where the processes is repeated.

If an HTTP error message was returned in response to the request (Block 735 returns a result of YES), the example domain processor 225 parses the domain name of the request to extract the census ID. In examples disclosed herein, a regular expression is used to extract the census ID from the domain name. However, any other approach to extracting the census ID may additionally or alternatively be used. For example, a pattern of a domain name having a four digit number followed by “.webid.nielsen.com” may be used, where the four digit number is representative of the census ID. Of course, other patterns may additionally or alternatively be used such as, for example, a domain name including twenty five hexadecimal characters followed by “.webid.nielsen.com”. The example crediting processor 235 then stores an association of the census ID (parsed by the domain processor 225 in block 740) and the panelist ID (determined by the crediting processor 235 in block 720) in the example panelist ID to census ID association table 450 stored in the example panelist crediting database 240. (Block 745). Of course, the association of the census ID and the panelist ID may be stored in any other location.

The example proxy log parser 220 determines whether there are any additional records to be processed (Block 730). If additional records are to be processed, control proceeds to block 715 where the processes is repeated until no additional records exist (e.g., until block 730 returns a result of NO).

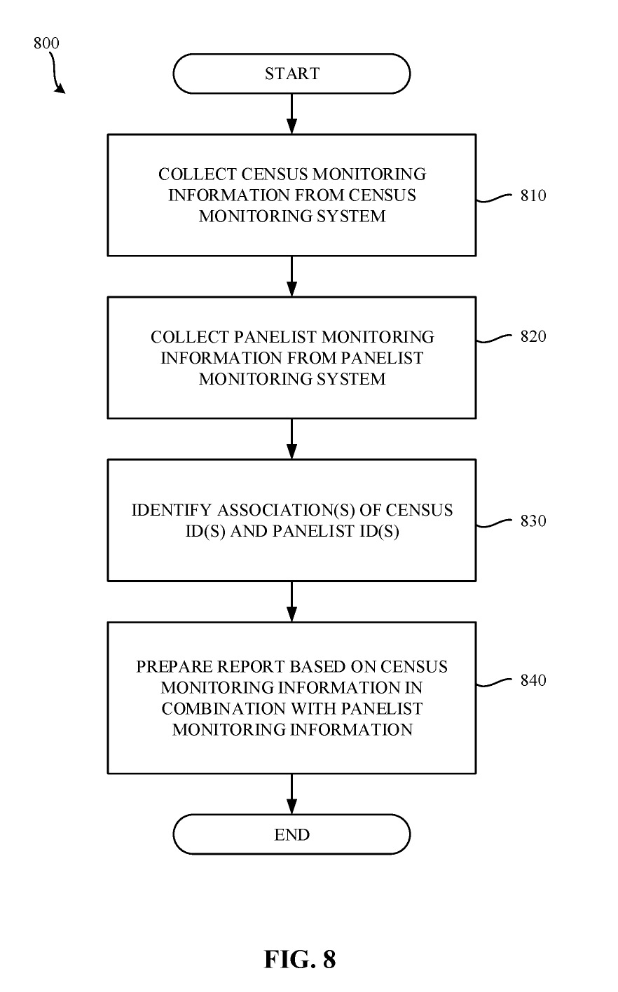

FIG. 8 is a flowchart representative of example machine-readable instructions 800 which, when executed by the example reporting system 142, cause the example reporting system 142 to prepare a report based on an association of the panelist ID and the census ID. The example program 800 of FIG. 8 begins when the example reporting system 142 collects census monitoring information from the census monitoring system 141. (Block 810). In examples disclosed herein, the census monitoring information is accessed from the census crediting database 340. However, the census monitoring information may be accessed from any other location. The example reporting system 142 collects panelist monitoring information from the panelist monitoring system 143. (Block 820). In examples disclosed herein, the panelist monitoring information is accessed from the panelist crediting database 240. However, the panelist monitoring information may be accessed from any other location.

The example reporting system 142 identifies association(s) of census ID(s) and panelist ID(s) stored by the crediting processor 235. (Block 830). In examples disclosed herein, the association(s) of the census ID(s) and the panelist ID(s) is accessed from the panelist crediting database 240. However, the association(s) of the census ID(s) and the panelist ID(s) may be accessed in any other fashion and/or from any other location. For example, upon the determination of the association by the crediting processor 235, the example crediting processor 235 may provide the association(s) of the census ID(s) and the panelist ID(s) to the reporting system 142.

Using the census monitoring information, the panelist monitoring information, and the association(s) of the census ID(s) and the panelist ID(s), the example reporting system 142 prepares a report. (Block 840). Unlike a report that is based entirely on census monitoring information, the report created by the reporting system 142 utilizes demographic information of panelists to supplement and/or correct demographic information estimated in association with the census monitoring information. Using multiple data sources (e.g., the census monitoring system and the panelist monitoring system) enables enhanced accuracy of the resultant report.

FIG. 9 is a block diagram of an example processor platform 900 capable of executing the instructions of FIGS. 6, 7, and/or 8 to implement the example audience measurement entity 140 of FIG. 1. The processor platform 900 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer.

The processor 912 of the illustrated example includes a local memory 913 (e.g., a cache), and executes instructions to implement the example proxy log falterer 215, the example proxy log parser 220, the example domain processor 225, the example registrar 230, the example crediting processor 235, the example monitoring instruction provider 310, the example census ID generator 320, the example census data receiver 330, and/or the example reporting system 142. The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives. In the illustrated example of FIG. 9, the example mass storage devices 928 implement the example proxy log database 145. However, the example mass storage devices 928 may additionally or alternatively implement the example panelist crediting database 240 and/or the example census crediting database 340.

The coded instructions 932 of FIGS. 6, 7, and/or 8 may be stored in the mass storage device 928, in the volatile memory 914, in the non-volatile memory 916, and/or on a removable tangible computer readable storage medium such as a CD or DVD.

FIG. 10 is a block diagram of an example processor platform 1000 capable of executing the instructions of FIG. 5 to implement the example mobile device 105 of FIG. 1. The processor platform 1000 can be, for example, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache), and executes instructions to implement example browser 107 of the example mobile device 105. The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1020 of the illustrated example, thus, typically includes a graphics driver card, a graphics driver chip or a graphics driver processor. The example output devices 1024 of the illustrated example implement the example user interface 109 of the example mobile device 105.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.). The example interface circuit 1020 of the illustrated example implements the example device networking subsystem 106.

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives. The example mass storages devices 1028 implement the example memory 108 of the example mobile device 105.

The coded instructions 1032 of FIG. 4 may be stored in the mass storage device 1028, in the volatile memory 1014, in the non-volatile memory 1016, and/or on a removable tangible computer readable storage medium such as a CD or DVD.

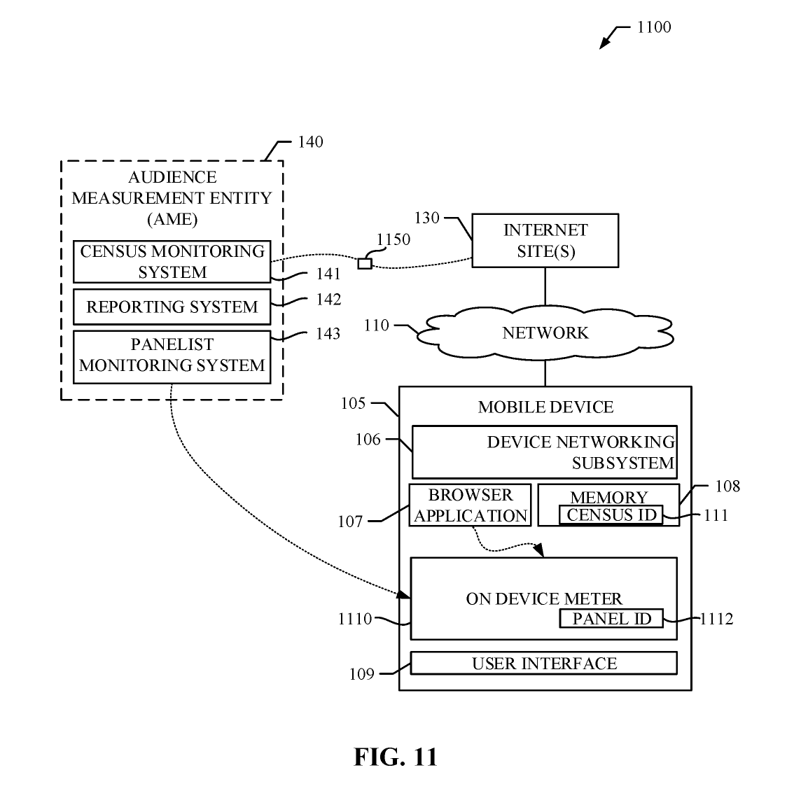

FIG. 11 illustrates an example alternative approach to associating a panelist ID 1112 with a census ID 111. In the illustrated example of FIG. 11, the panelist monitoring system 143 provides an on-device meter 1110 to the mobile device 105 along with a panelist ID 1112. The on-device meter 1110 is locally executed by the mobile device 105 to monitor media presentations of the mobile device 105 and report the identity of the monitored media presentation and the panelist ID 1112. In the illustrated example of FIG. 11, the census monitoring system 141 provides monitoring instructions 1150 to the Internet site(s) 130 which, when transmitted to the mobile device 105 (e.g., in response to a request for a webpage), cause the browser 107 of the mobile device to provide the census ID 111 from the memory 108 of the mobile device 105 to the on-device meter 1110. In such a manner, the example on-device meter 1110 may report the panelist ID 1112 and the census ID 111 as associated with each other to the audience measurement entity 140.

From the foregoing, it will be appreciated that the above disclosed methods, apparatus and articles of manufacture enable panelist identifiers used when collecting panelist monitoring information to be associated with census identifiers used when collecting census monitoring information. Such association enables reports that, for example, utilize demographic information of panelists to supplement and/or correct demographic information estimated in association with the census monitoring information.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to associate panelist data with census data, the method comprising:
accessing a log of communications from a proxy;
identifying a record from the log of communications;
determining, by executing a first instruction with a processor, a panelist identifier associated with the record based on a port number used in a request represented by the record;
determining, by executing a second instruction with the processor, whether a domain name of the request represented by the record matches a pattern including a census identifier; and
in response to the processor determining that the domain name of the request represented by the record matches the pattern, storing the census identifier in association with the panelist identifier in a memory by executing a third instruction with the processor.

2. The method as described in claim 1, further including determining whether a response represented by the record indicates the occurrence of an error message in response to the request represented by the record, and the storing of the census identifier is performed in response to determining that the response represented by the record indicates the occurrence of the error message.

3. The method as described in claim 2, wherein the error message indicates that an address of the request represented by the record could not be found.

4. The method as described in claim 1, wherein a fourth instruction provided to a mobile device by a census monitoring system causes the mobile device to transmit the request represented by the record to a domain that includes the census identifier via the proxy.

5. The method as described in claim 1, further including uniquely assigning the port number to a panelist of the mobile device.

6. The method as described in claim 1, further including extracting the census identifier from the domain name.

7. The method as described in claim 1, wherein the census identifier is represented by a sub-domain of the domain name of the request.

8. A tangible machine-readable storage disk or storage device comprising instructions which, when executed, cause a processor to at least:
access a log of communications from a proxy;
identify a record from the log of communications;
determine a panelist identifier associated with the record based on a port number used in a request represented by the record;
determine whether a domain name of the request represented by the record matches a pattern including a census identifier; and
in response to determining that the domain name of the request represented by the record matches the pattern, store the census identifier in association with the panelist identifier.

9. The tangible machine-readable storage disk or storage device as described in claim 8, wherein the instructions, when executed, cause the processor to determine whether a response represented by the record indicates the occurrence of an error message in response to the request represented by the record, and the storing of the census identifier is performed in response to determining that the response represented by the record indicates the occurrence of the error message.

10. The tangible machine-readable storage disk or storage device as described in claim 9, wherein the error message indicates that an address of the request represented by the record could not be found.

11. The tangible machine-readable storage disk or storage device as described in claim 8, wherein a monitoring instruction provided to a mobile device by a census monitoring system causes the mobile device to transmit the request represented by the record to a domain that includes the census identifier via the proxy.

12. The tangible machine-readable storage disk or storage device as described in claim 8, wherein the port number is uniquely associated with a panelist of the mobile device.

13. The tangible machine-readable storage disk or storage device as described in claim 8, wherein the instructions, when executed, cause the processor to extract the census identifier from the domain name.

14. The tangible machine-readable storage disk or storage device as described in claim 8, wherein the census identifier is represented by a sub-domain of the domain name of the request.

15. An apparatus to associate panelist data with census data, the apparatus comprising:
a proxy log parser to identify a record from the log of communications;
a crediting processor to determine a panelist identifier associated with the record based on a port number used in a request represented by the record; and
a domain processor to determine whether a domain name of the request represented by the record matches a pattern including a census identifier, wherein the crediting processor is to store the census identifier in association with the panelist identifier in response to the domain processor determining that the domain name of the request represented by the record matches the pattern.

16. The apparatus as described in claim 15, wherein the crediting processor is further to determine whether a response represented by the record indicates that an error message was received in response to the request represented by the record, and wherein the crediting processor is to store the census identifier in response to the determination that the response represented by the record indicates that the error message was received.

17. The apparatus as described in claim 16, wherein the error message indicates that an address of the request represented by the record could not be found.

18. The apparatus as described in claim 15, further including a monitoring instruction provider to provide, via an Internet site, a monitoring instruction to a mobile device, the monitoring instruction to cause the mobile device to transmit the request represented by the record to a domain that includes the census identifier via the proxy.

19. The apparatus as described in claim 15, further including a registrar to uniquely assign the port number to a mobile device.

20. The apparatus as described in claim 15, wherein the census identifier is represented by a sub-domain of the domain name of the request.
